(19) United States
(12) Patent Application Publication
(10) Pub. No.: US 2008/0304117 A1
(43) Pub. Date: Dec. 11, 2008

(54) IMAGE READING APPARATUS

(75) Inventors: Takeshi Aoyama, Abiko-shi (JP); Ayumu Murakami, Abiko-shi (JP); Shoko Magata, Toride-shi (JP); Yuichi Yamamoto, Toride-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/123,884

(22) Filed: May 20, 2008

(30) Foreign Application Priority Data
Jun. 5, 2007 (JP) 2007-149518

(51) Int. Cl. H04N 1/04

(52) U.S. Cl. 358/498

(57) ABSTRACT

An image reading apparatus has: a setting unit; a sheet conveying unit; a reading unit which can read an image of the sheet conveyed onto the setting unit by the sheet conveying unit and can read the image of the sheet set onto the setting unit; and an abutting unit which abuts an edge of the sheet which is set onto the setting unit, said edge of the sheet crosses a sheet conveying direction of the sheet conveying unit. The abutting unit is provided at a position where it is not come into contact with the sheet conveyed by the sheet conveying unit.

### BACKGROUND OF THE INVENTION

1. Field of the Invention

The present invention relates to an image reading apparatus for reading an image of a sheet.

2. Description of the Related Art

Hitherto, in an image reading apparatus, in order to read an image of a sheet, for example, after an original document as a sheet was set onto original setting base glass as a sheet setting base plate, the original is pressed by an original pressing plate, thereby fixing the original. An image reading unit arranged under the original setting base glass is moved in the reading direction in such a state, thereby reading an image recorded on the original.

There is an apparatus in which a back surface of an automatic document feeder (ADF) for automatically conveying the original onto the original setting base glass is used as an original pressing plate serving as a sheet pressing unit. In the case of reading the original, the ADF is closed.

FIG. 11 is a diagram illustrating a schematic construction of an image reading apparatus in the related art as mentioned above. An image reading apparatus J has: a scanner unit 8 for reading an image of the original; and an automatic document feeder (hereinbelow, abbreviated to ADF) 11 for conveying the original onto original setting base glass 12.

The ADF 11 is closably provided for the scanner unit 8 so that it can expose the original setting base glass 12. The ADF 11 has: a sheet feeding tray 2 on which original documents S are stacked; a pickup roller 3; a separating unit 4; a conveying roller 5; a registration roller 6; and a conveying belt 7.

In the image reading apparatus J, for example, the originals stacked on the sheet feeding tray 2 are conveyed onto the original setting base glass 12 one by one by the ADF 11, thereby reading the original image.

In the case of reading the originals S stacked on the sheet feeding tray 2, the ADF 11 separates and feeds the originals S stacked on the sheet feeding tray 2 by the pickup roller 3 and the separating unit 4 one by one. Thereafter, the original S is conveyed onto the original setting base glass 12 by the conveying roller 5, registration roller 6, and conveying belt 7 and stopped at a predetermined reading position.

Subsequently, the scanner unit 8 reads the image of the original S stopped at the reading position on the original setting base glass 12. In the case of reading images of both sides of the original S, the reverse and obverse surfaces of the original are reversed by a reversing unit 9, thereafter, the original S is stopped again at the reading position on the original setting base glass 12 and the image of the reverse surface of the original is read. After the image was read, the original S is conveyed to an ejecting unit 10 by the conveying belt 7 and discharged onto a sheet discharging tray 13 by the ejecting unit 10.

In the image reading apparatus J, depending on the type of original S or the number of originals, the original S is put onto the original setting base glass 12 by the operator without using the ADF 11 and, thereafter, the original image is read. In the case of reading the image of the original set on the original setting base glass 12, first, the original S is set onto the original setting base glass 12 and the original image is read by the scanner unit 8.

In the case of setting the original S onto the original setting base glass 12, the original S is abutted to an index plate 31 provided for the original setting base glass 12, thereby deciding a position of one side edge (of the original S) which is parallel with an original conveying direction M of the conveying belt 7 illustrated in FIG. 12. The positioning of one end in the original conveying direction is performed by a method whereby the operator matches an edge (corner portion) of the original S on the upstream side in the original conveying direction with a mark 31a shown on the index plate 31 (Japanese Patent Application Laid-Open No. H06-156751).

However, in the image reading apparatus in the related art, when the edge portion (corner portion) of the original is matched with the mark 31a written on the index plate 31 for the purpose of positioning of the original conveying direction, since its operation depends on the sense of sight of the operator, there is a case where the operator sets the original to a wrong position. That is, in the image reading apparatus in the related art, there is a risk that the original is set to the incorrect position in the original conveying direction, so that the image cannot be correctly read.

If a plate adapted to abut the edge portion of the original to the edge portion of the original setting base glass 12 which perpendicularly crosses the original conveying direction is provided, it is possible to prevent the operator from setting the original to the wrong position. However, if such a plate is provided, when the original is conveyed by the conveying belt, there is a case where the original is hooked to the index plate or the conveyance of the original does not stable due to a difference between heights of the plate and the original setting base glass 12. Therefore, such a problem that the original cannot be smoothly conveyed occurs.

### SUMMARY OF THE INVENTION

Therefore, the invention is made in consideration of such a present situation and it is an object of the invention to provide an image reading apparatus and an image forming apparatus in which an image can be correctly read and an original (sheet) can be smoothly conveyed.

According to the invention, there is provided an image reading apparatus comprising: a setting unit on which a sheet is set; a sheet conveying unit which conveys the sheet onto the setting unit; a reading unit which can read an image of the sheet which is conveyed onto the setting unit by the sheet conveying unit and can read the image of the sheet set onto the setting unit; and an abutting unit which abuts an edge of the sheet which is set onto the setting unit, said the edge of the sheet crosses a sheet conveying direction of the sheet conveying unit, wherein said abutting unit is provided at a position where it is not come into contact with the sheet that is conveyed by the sheet conveying unit.

According to the invention, when the operator sets the sheet onto the setting unit, the abutting unit to which the edge of the sheet which crosses the sheet conveying direction is abutted is provided at a position which is not come into contact with the sheet which is conveyed by the sheet conveying unit, so that the image can be correctly read and the sheet can be smoothly conveyed.

Further features of the present invention will become apparent from the following description of exemplary embodiments with reference to the attached drawings.

### BRIEF DESCRIPTION OF THE DRAWINGS

FIG. 1 is a schematic constructional diagram of a digital scanner as an example of an image reading apparatus according to the first embodiment of the invention.

FIG. 2 is a perspective view illustrating a state where an automatic document feeder having a scanner unit of the digital scanner is opened.

FIG. 3 is a top view illustrating a construction around the platen glass of the scanner unit.

FIG. 4 is a top view for describing an original conveying region on the platen glass according to the ADF.

FIG. 5 is a control block diagram of the digital scanner.

FIG. 6A is a diagram illustrating a state when the scanner unit reads an image of an original set on the platen glass; and FIG. 6B is a diagram illustrating a state when the scanner unit reads the image of the original which has been conveyed by the ADF and stopped on the platen glass.

FIG. 7 is a flowchart illustrating the original image reading operation of the digital scanner.

FIG. 8 is a top view of a scanner unit of a digital scanner according to the second embodiment of the invention.

FIG. 9 is a first diagram illustrating another construction of the ADF of the digital scanner according to each of the first and second embodiments.

FIG. 10 is a second diagram illustrating another construction of the ADF of the digital scanner according to each of the first and second embodiments.

FIG. 11 is a diagram illustrating a schematic construction of an image reading apparatus in the related art.

FIG. 12 is a diagram for describing a construction of an index plate in the related art.

FIG. 13 is a diagram for describing the image reading area of scanner unit in the main scanning direction.

### DESCRIPTION OF THE EMBODIMENTS

Preferred embodiments of the present invention will now be described in detail in accordance with the accompanying drawings.

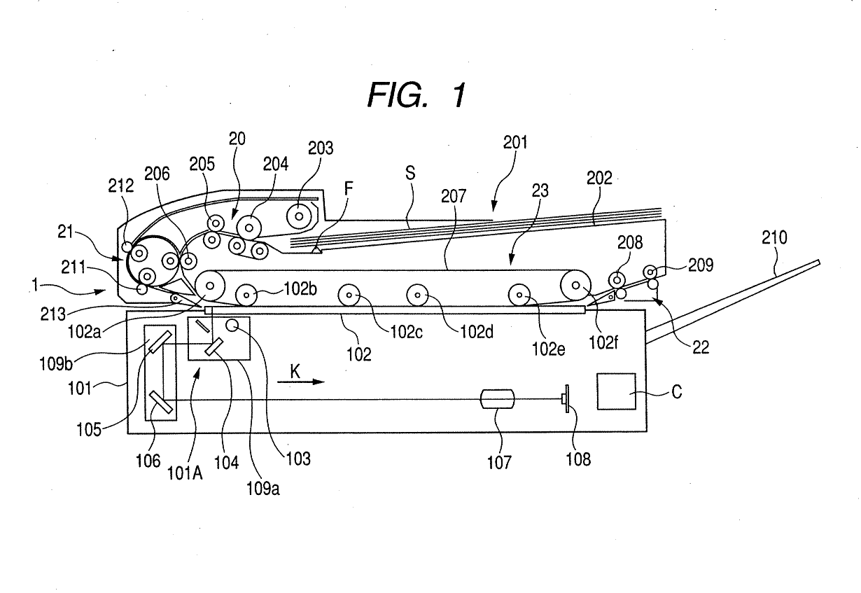

FIG. 1 is a schematic constructional diagram of a digital scanner as an example of an image reading apparatus according to the first embodiment of the invention.

In FIG. 1, a digital scanner 1 has: a scanner unit 101 for reading an image of an original as a sheet; and an automatic document feeder (ADF) 201 provided on an upper surface of the scanner unit 101 so as to be closable in the vertical direction.

The scanner unit 101 constructing an apparatus main body has: platen glass (sheet setting base plate) 102 provided on the upper surface of the scanner unit 101 (upper surface of the apparatus main body); and an image reading unit 101A for scanning and reading the image of the original on the platen glass 102.

The image reading unit 101A has: a lamp 103 for irradiating light onto the original; and a first mirror 104, a second mirror 105, and a third mirror 106 for turning back the reflection light from the original. The image reading unit 101A further has: a lens 107 for forming an image of the reflection light from the mirrors 104 to 106; and a CCD (Charge Coupled Device) element 108 for reading the original image formed by the lens 107.

The lamp 103 and the first mirror 104 for scanning the original are held by a first carriage 109a so as to be movable in a K direction as a sub-scanning direction illustrated in FIG. 1. Similarly, the second mirror 105 and the third mirror 106 are held by a second carriage 109b so as to be movable in the K direction.

When the image of the original S set onto the platen glass 102 by the operator is read, the first and second carriages 109a and 109b are moved in the K direction by motors (not shown). When they are moved in this manner, the light is irradiated from the lamp 103 onto the surface of the original on the platen glass. The reflection light from the original S is guided to the lens 107 through the first to third reflecting mirrors 104 to 106 and formed as an image by the lens 107 onto a photosensing portion of the CCD element 108, so that the original image is read.

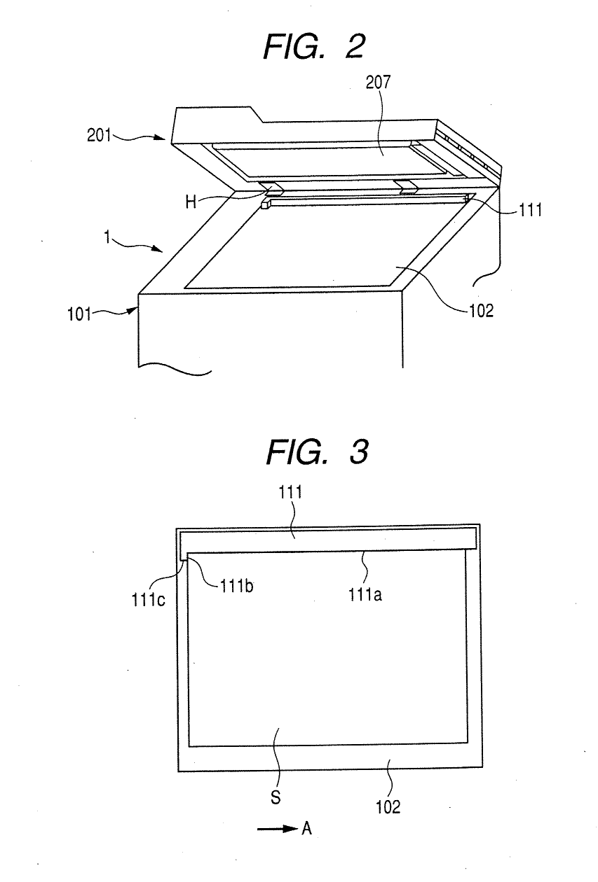

The ADF 201 constructs a sheet pressing unit for pressing the original set onto the platen glass 102 from the upward direction. As illustrated in FIG. 2, the ADF (a sheet conveying unit) 201 is attached to the scanner unit 101 by hinges H so as to be closable around an axis which is parallel with the sheet conveying direction in the scanner unit 101 as a center.

By opening the ADF 201, the platen glass 102 can be opened. In order to set the original onto the platen glass 102, first, the ADF 201 is opened so as to open the platen glass 102 as illustrated in FIG. 2. After the platen glass 102 was opened in this manner, the operator sets the original to a predetermined image reading position on the platen glass 102.

As illustrated in FIG. 1, the ADF 201 has: an original tray 202 on which the originals S are set; a feeding unit 20 serving as a sheet conveying unit; and an ejecting unit 22. The originals S are set on the original tray 202 in a state where an image forming surface faces upward. The feeding unit 20 sequentially takes out the originals S one by one from the top sheet and supplies to one end side (left edge side in the diagram) of the platen glass 102.

The feeding unit 20 has: a pickup roller 203 for feeding the originals set on the original tray 202; and a separating unit 204 for separating the originals one by one fed by the pickup roller 203. The feeding unit 20 further has: a conveying roller pair 205 for conveying the original S separated one by one by the separating unit 204 toward the platen glass 102; and a registration roller 206. An original presence/absence sensor F for detecting whether or not the originals S have been set onto the original tray 202 is provided at a position corresponding to an edge portion of the originals S set on the original tray 202.

The feeding unit 20 has an original conveying unit 23 for conveying the original S onto the platen glass 102. A conveying belt 207 serving as a conveying unit is provided for the original conveying unit 23 so as to cover the upper surface of the platen glass 102. The original S fed by the registration roller 206 is conveyed from one end (left edge) side of the platen glass 102 to the other end (right edge) side and ejected onto an ejecting tray 210 by an ejection conveying roller pair 208 and an ejecting roller 209 which construct the ejecting unit 22.

The conveying belt 207 serving as a rotational member is suspended around belt rollers 102a to 102f and can be forwardly and reversely rotated. Thus, the original conveyed onto the platen glass 102 can be fed out of the platen glass 102 to any of the left edge side and the right edge side in FIG. 1 by the conveying belt 207.

The feeding unit 20 has a reversing unit 21 for reversing the obverse and reverse surfaces of the original S. The reversing unit 21 is constructed by reverse conveying rollers 211 and 212. The reversing unit 21 receives the original S fed out of the left edge side of the platen glass 102 by the conveying belt 207, conveys the original so as to reverse the obverse and reverse surfaces, and conveys the original S again to the conveying belt side through the registration roller 206.

In FIG. 1, a control unit C controls the image reading operation of the digital scanner 1. The control unit C controls, for example, an image reading range of the image reading unit 101A, which will be described hereinafter, in a depth direction which perpendicularly crosses the original conveying direction.

Subsequently, the original image reading operation of the digital scanner 1 having the ADF 201 constructed as mentioned above will be described.

First, the operation to read the image of the original conveyed onto the platen glass by the ADF 201 will be described.

In this case, first, in the ADF 201, after the feed roller 203 was come into contact with the upper surface of the original S, the feed roller 203 is rotated, thereby conveying the top original S to the separating unit 204. When a plurality of originals S have been conveyed in an overlaid state, the top original S is separated from the other originals by the separating unit 204 and conveyed.

Subsequently, the one separated original S is conveyed to the stopped registration roller 206 by the conveying roller pair 205 and, thereafter, its front edge is aligned by the registration roller 206. After that, when the registration roller 206 rotates, the original S is conveyed to the conveying belt 207. Then, the original S is conveyed to a predetermined image reading position on the platen glass 102 by the conveying belt 207 and stopped at this position.

After the original S was stopped at the image reading position as mentioned above, the first and second carriages 109a and 109b are moved in the direction shown by the arrow K and the original S on the platen glass 102 is illuminated by the lamp 103. After the reflection light from the original S was guided to the lens 107 through the first to third reflecting mirrors 104 to 106, it is formed as an image by the lens 107 onto the photosensing portion of the CCD element 108 and the original image is converted into an electric signal.

After the image was read in this manner, the original S is conveyed to the ejecting unit 22 side by the conveying belt 207 and ejected onto the ejecting tray 210 by the ejection conveying roller pair 208 and the ejecting roller 209.

In the embodiment, after the image of the original S was read, the ADF 201 can selectively convey the original S in the same direction as the original conveying direction or in the direction opposite to the original conveying direction. For this purpose, a reverse sheet feeding flapper 213 for selectively guiding the original which has passed through the registration roller 206 to the reversing unit 21 is arranged on the downstream side of the registration roller 206.

In the case where the original S whose image has been read is ejected onto the original tray 202, the conveying belt 207 is reversed and the reverse sheet feeding flapper 213 is switched, thereby guiding the original to the original tray 202.

In the case of reading the image of the reverse surface of the original S, after the image of one side was read, the original S is ejected from the left edge of the platen glass 102 in FIG. 1 and conveyed by the conveying belt 207 and the reverse conveying rollers 211 and 212. After that, the original is conveyed again onto the platen glass 102 by the registration roller 206 and the conveying belt 207, thereby reversing the reverse and obverse surfaces of the original S.

After the image was read in a manner similar to the case of reading the image of one side, the reverse and obverse surfaces are further reversed again by the reversing unit 21. Subsequently, the original S is ejected onto the ejecting tray 210 by the conveying belt 207, ejection conveying roller pair 208, and ejecting roller 209.

The control of each unit regarding the original feeding by the ADF 201 mentioned above is also made by the control unit C. The operation in which the original conveyed by the conveying belt 207 is temporarily stopped on the platen glass 102 and the image of the stopped original is read has been described above. However, the image reading apparatus of the embodiment can also read the image of the original while conveying the original by the conveying belt 207.

In the case of reading the original image in a state where the original has been set onto the platen glass 102, first, the ADF 201 is rotated upward and opened as illustrated in FIG. 2 and, thereafter, the operator sets the original onto the platen glass 102.

In the embodiment, an index plate 111 is provided on the rear side, that is, the ADF side of the platen glass 102 (scanner unit 101) as illustrated in FIG. 3. The index plate 111 is a positioning member for positioning the original S when the original S is set onto the platen glass 102.

The index plate 111 has a first abutting portion 111b which is projected from the upper surface of the platen glass 102 and is used to allow an edge of the original which crosses the original conveying direction (sheet conveying direction) shown by an arrow A of the original S to abut. The index plate 111 further has a second abutting portion 111a which is projected from the upper surface of the platen glass 102, is extended in the original conveying direction, and is used to allow a side edge of the original which is parallel with the original conveying direction (sheet conveying direction) shown by the arrow A of the original S, for example, the side edge on the rear side to abut.

An index mark serving as a reference for the operator to recognize an original size has been formed in the second abutting portion 111a.

When the original S is set onto the platen glass 102, the side edge on the rear side of the original S is abutted to the second abutting portion 111a and the left edge is abutted to the first abutting portion 111b, thereby positioning the original S to the image reading position.

If the first abutting portion 111b is projected, when the original S conveyed onto the platen glass 102 is ejected from the platen glass 102 onto the original tray 202, there is a risk that the original S and the first abutting portion 111b are interfered. If the original S and the first abutting portion 111b are interfered, the original S cannot be smoothly conveyed.

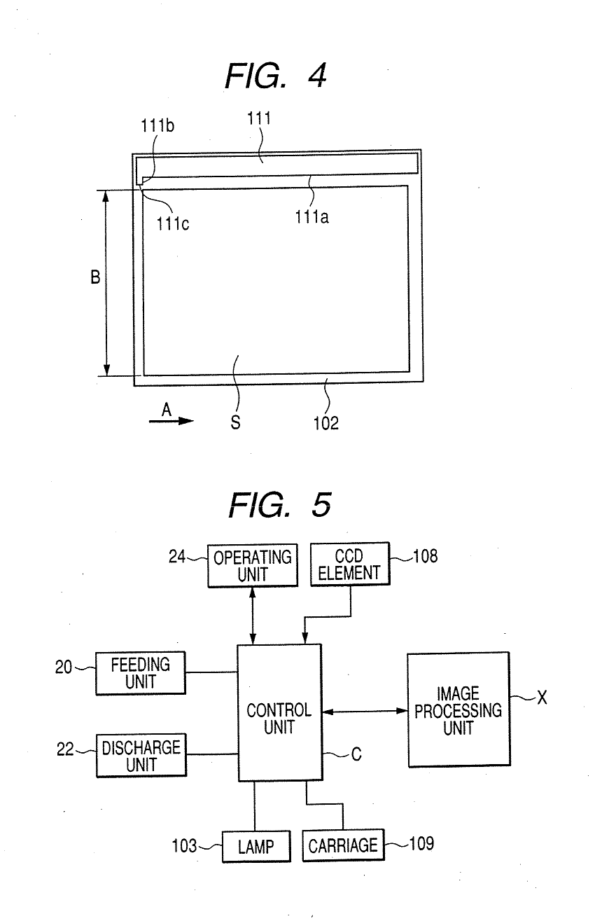

In the embodiment, therefore, in FIG. 4, the side edge of the second abutting portion in an original conveying region B is set to be away from an edge portion 111c of the first abutting portion 111b. The original conveying region B is a region on the platen glass 102 where the original S which is conveyed by the conveying belt 207 passes. Specifically speaking, the original conveying region B is deviated in the depth direction as a sheet conveying direction so as to be away from the first abutting portion 111b by a distance corresponding to a length of first abutting portion 111b in the depth direction.

By deviating the original conveying region B, the original S passes through the position away from the edge portion 111c of the first abutting portion 111b and is conveyed onto the platen glass 102 by the conveying belt 207 and is stopped, and the image is read here. When the conveying belt 207 is reversely rotated in order to reverse the original S, the original S is conveyed in the direction opposite to the arrow A (in the direction of the reversing unit 21). However, in this case, the original S also passes through the position away from the edge portion 111c of the first abutting portion 111b.

By deviating the original conveying region B in the depth direction of the first abutting portion 111b as mentioned above, the interference between the first abutting portion 111b and the conveyed original S can be avoided. Thus, the original S can be smoothly conveyed by the ADF 201 without being hooked to the first abutting portion 111b of the index plate 111.

When the original conveying region B is provided as mentioned above, the reading position of the original S which has directly been set onto the platen glass 102 by the operator differs from the reading position of the original S conveyed by the ADF 201.

In the embodiment, therefore, the image reading range by the image reading unit 101A in the case of reading the original image conveyed by the ADF 201 and that in the case of reading the image of the original which has been set onto the platen glass 102 by the operator are made different. In other words, the image reading range of the original conveyed by the ADF 201 is deviated from the image reading range of the original set on the platen glass 102 in the depth direction by at least the distance corresponding to the length of first abutting portion 111b in the depth direction.

Such control of deviating the image reading range in the depth direction of the image reading unit 101A is made by the control unit C (refer to FIG. 1) as already mentioned above.

FIG. 5 is a block diagram of the digital scanner 1. The control unit C controls: turn-on/off of the lamp 103 for irradiating the light onto the original; ON/OFF of the driving motors (not shown) for driving and moving the carriages 109; and the reading of the reflection light of the original by the CCD element 108, respectively. Image information of the original read by the CCD element 108 is sent to an image processing unit X by the control unit C and predetermined image processes are executed in the image processing unit X. The control unit C also controls the driving of the feeding unit 20 and the ejecting unit 22 of the ADF 201.

An original reading mode of the digital scanner 1 is set by an operating unit 24.

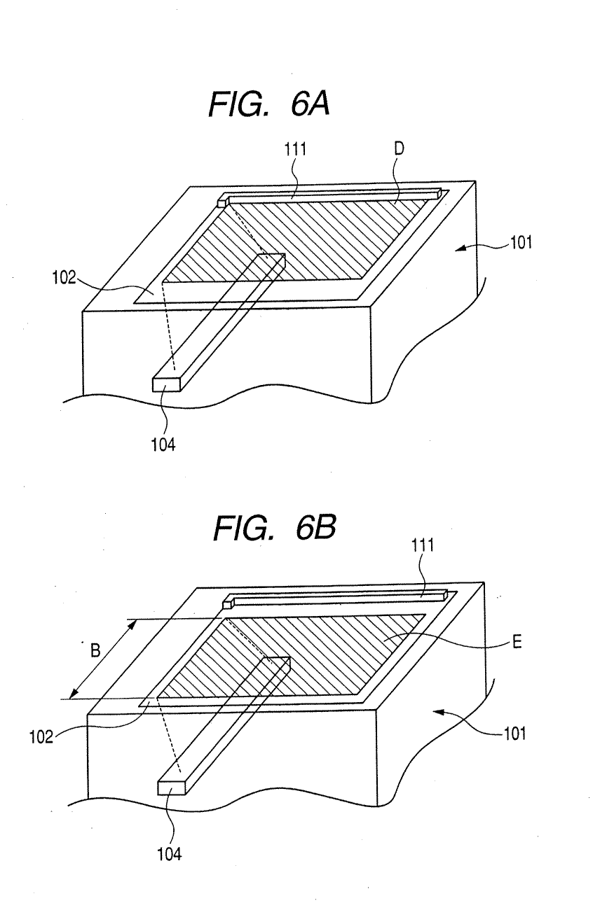

FIGS. 6A and 6B are diagrams for describing a state when the scanner unit 101 reads the original. FIG. 6A is a diagram illustrating the state when the scanner unit 101 reads the image of the original set on the platen glass by the operator. FIG. 6B is a diagram illustrating the state when the scanner unit 101 reads the image of the original which has been conveyed by the ADF 201 and stopped on the platen glass 102.

When the operator sets the original S onto the platen glass, the original S is positioned onto the platen glass 102 since the side edge on the rear side and the left edge are abutted to the second abutting portion 111a and the first abutting portion 111b of the index plate 111, respectively. As illustrated in FIG. 6A, the control unit C controls the scanner unit 101 so that an image in a region D corresponding to the setting region of the original positioned by the index plate 111 is read as a valid image. Such an original image reading is hereinbelow referred to as a set original reading mode.

When the original is conveyed by the ADF 201, the original is stopped at a predetermined stop position on the platen glass in the original conveying region B. As illustrated in FIG. 6B, the control unit C controls the scanner unit 101 so that an image in a region E corresponding to the original stopped at the stop position is read as a valid image. Such an original image reading is hereinbelow referred to as a conveyance original reading mode.

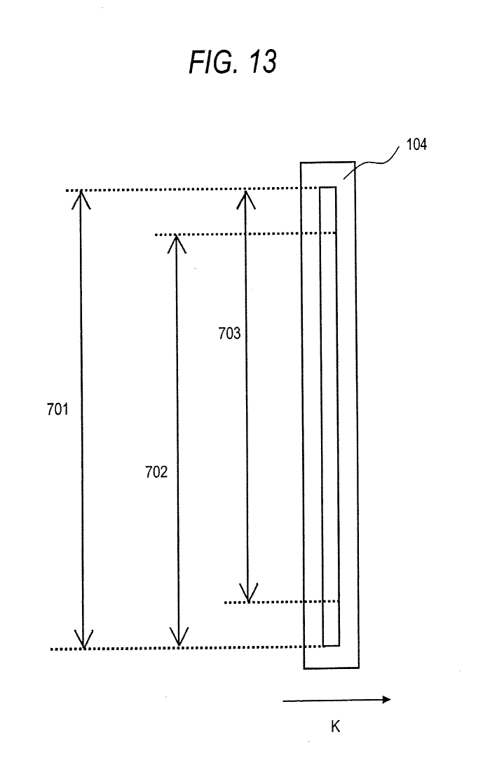

FIG. 13 is a diagram for describing the reading area of the scanner unit 101 in the main scanning direction (the direction perpendicular to the moving direction K of the image reading unit 101A). The scanner unit 101 can read the image of document on the reading area 701.

In the set original reading mode, the scanner unit 101 reads the image of document in an upper reading area 703. The scanner unit 101 reads the image of document while the image reading unit 101A is moving in the direction K. Therefore the upper reading area 703 corresponds to the region D in FIG. 6A in the main scanning direction.

In the conveyance original reading mode, the scanner unit 101 read the image of document in a lower reading area 702. The scanner unit 101 reads the image of document while the image reading unit 101A is moving in the direction K. Therefore the lower reading area 702 corresponds to the region E in FIG. 6B in the main scanning direction.

The region on the platen glass 102 which is read by the scanner unit 101 (image reading unit 101A) in the set original reading mode and that in the conveyance original reading mode are different. Thus, in the case of the conveyance original reading mode, the original S can be smoothly conveyed without being hooked to the first abutting portion 111b of the index plate 111. The ADF 201 is constructed in such a manner that the original conveyed by the ADF 201 passes through the original conveying region B in the conveyance original reading mode.

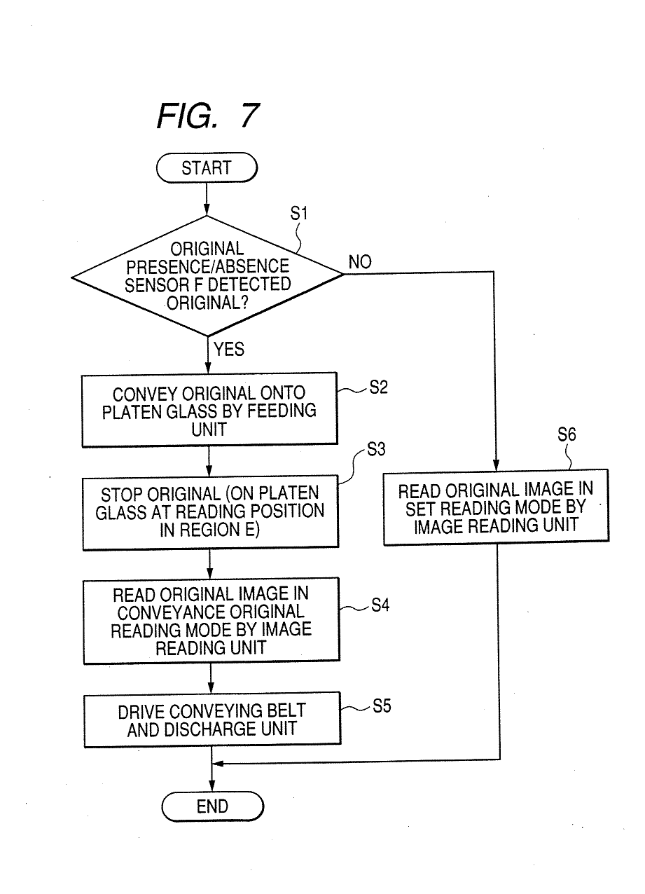

Subsequently, the original image reading operation of the digital scanner 1 having the set original reading mode and the conveyance original reading mode will be described with reference to a flowchart of FIG. 7.

First, when a read button (not shown) in the operating unit 24 is pressed, the control unit C detects the presence or absence of the original on the original tray 202 by the original presence/absence sensor F (S1). If the original exists on the original tray 202 here (YES in S1), as already mentioned above, the original is conveyed onto the platen glass 102 by (the conveying belt 207 of) the feeding unit 20 (S2). After that, when the original reaches the predetermined reading position in the region E on the platen glass 102 illustrated in FIG. 6B, the conveyance of the original is stopped (S3).

Subsequently, the control unit C controls the scanner unit 101 and reads the image of the original stopped at the reading position by the image reading unit 101A in the conveyance original reading mode as a first mode (S4). When finishing the reading in the conveyance original reading mode, the control unit C drives the conveying belt 207 and the ejecting unit 22 (S5), thereby ejecting the original onto the ejecting tray 210.

When the read button is pressed, if it is detected by the original presence/absence sensor F that no originals are set onto the original tray (NO in S1), the control unit C controls the scanner unit 101 and reads the image of the original in the set original reading mode as a second mode (S6).

As described above, by projecting the first abutting portion 111b onto the upper surface of the scanner unit, when the original is set onto the platen glass 102, the original can be accurately set to the predetermined position on the platen glass 102 irrespective of the sense of sight of the operator. Thus, the read image of high positional precision can be obtained. In the conveyance original reading mode, since the original is conveyed in the region on the platen glass without the index plate, the original can be smoothly conveyed without being hooked to the first abutting portion 111b.

That is, by projecting the first abutting portion 111b of the index plate 111 at the position on the upper surface of the scanner unit where the first abutting portion 111b is not come into contact with the original which is conveyed by the ADF 201, the image can be accurately read and the original can be smoothly conveyed.

Although the second abutting portion 111a and the first abutting portion 111b are constructed as an identical integrated member in the embodiment, the abutting portions 111a and 111b may be formed by different members.

Although the case where the index plate 111 is provided for the platen glass 102 on the ADF side (sheet pressing portion side) has been described above, the invention is not limited to such a case. For example, the index plate 111 may be provided for the platen glass 102 on the side opposite to the ADF 201.

Subsequently, the second embodiment of the invention in which the index plate is provided for the platen glass on the side opposite to a rotary axis of the ADF (on the front side of the apparatus) as mentioned above will be described.

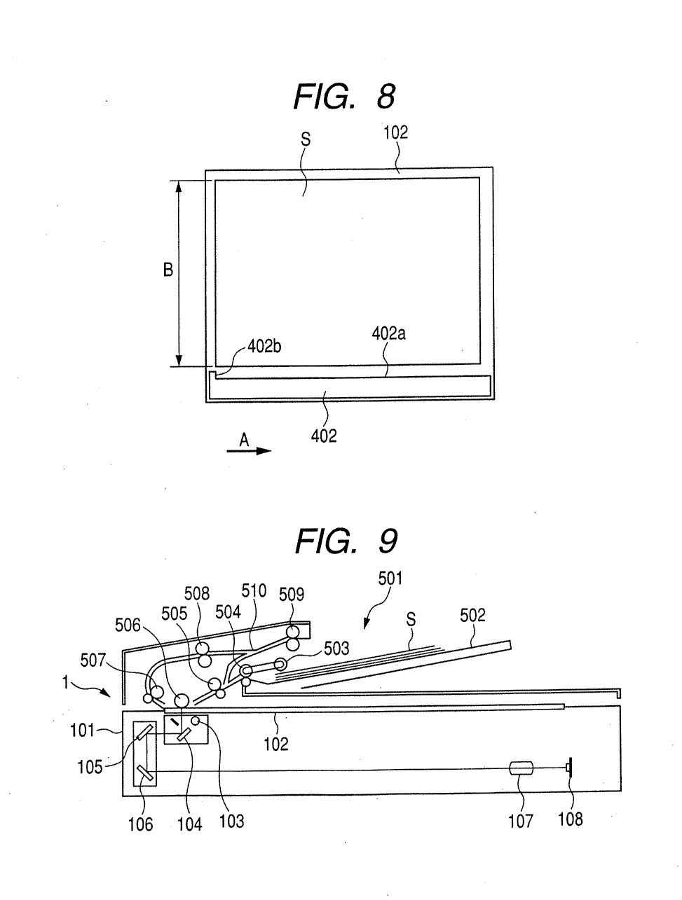

FIG. 8 is a top view of the scanner unit 101 of the digital scanner as an example of the image reading apparatus according to the second embodiment. In FIG. 8, the same and corresponding portions as those in FIG. 4 mentioned above are designated by the same reference numerals.

In FIG. 8, an index plate 402 is provided for the platen glass 102 on the side opposite to the ADF (on this side). The index plate 402 has a first abutting portion 402a which is extended in the original conveying direction and is used to allow a side edge of the original S on this side which is parallel with the original conveying direction shown by the arrow A to abut. The index plate 402 also has a second abutting portion 402b for allowing one end of the original S in the original conveying direction, for example, a corner portion of a rear edge in the original conveying direction to abut.

When the original image is read in the set original reading mode in which the operator sets the original onto the platen glass 102, the side edge on this side of the original S is abutted to the first abutting portion 402a and the left edge of the original S is abutted to the second abutting portion 402b.

By providing the index plate 402 on this side on the platen glass 102 in this manner, that is, by providing the index plate 402 on this side of the operator, when the operator sets the original S, the original S can be easily set.

Also in the second embodiment, the original conveying region B on the platen glass 102 in the conveyance original reading mode is set to the region on the platen glass 102 where the index plate 402 is not provided in a manner similar to the first embodiment. Thus, in the case of the conveyance original reading mode, the original S is conveyed without being hooked to the index plate 402.

In the foregoing first and second embodiments, the example in which after the original S was conveyed onto the platen glass 102 by the conveying belt 207, the lamp 103 and the first to third reflecting mirrors 104 to 106 are moved and the original is scanned has been shown. However, it is also possible to use a construction in which the lamp 103 and the first to third reflecting mirrors 104 to 106 are fixed to portions under the predetermined image reading position and while the original is conveyed by the conveying belt 207 in a portion over the image reading position, the original image is read.

In the foregoing first and second embodiments, the example in which the conveying belt is used as a conveying unit for conveying the original along the platen glass 102 has been shown. However, for instance, the original may be conveyed by rollers.

FIG. 9 is a diagram for describing a construction of the digital scanner 1 having the ADF in which the original is conveyed by rollers. In FIG. 9, the same and corresponding portions as those in FIG. 1 mentioned above are designated by the same reference numerals.

In FIG. 9, an ADF 501 is provided over the scanner unit 101 so as to be closable for the scanner unit 101. The originals S are stacked onto an original tray 502. A pickup roller 503 feeds the originals S stacked on the original tray 502. A separating roller 504 separates the originals S fed by the pickup roller 503. A platen roller 506 conveys the original onto the platen glass. An ejecting roller 509 ejects the conveyed original S. A conveying roller 505 is provided on the upstream side in the conveying direction of the platen roller 506 and conveying rollers 507 and 508 are provided on the downstream side, respectively.

Subsequently, the original image reading operation which is executed by the digital scanner 1 having such an ADF 501 in the conveyance original reading mode will be described.

In this case, first, the originals S set on the original tray 502 are separated and fed one by one by the pickup roller 503 and the separating roller 504. Thereafter, the original S is conveyed by the conveying roller 505 from the right side of the platen glass to the predetermined reading position on the platen glass 102. While the original S is pressed onto the platen glass 102 by the platen roller 506 arranged over the reading position, the original image is read.

At this time, the lamp 103 and the first to third reflecting mirrors 104 to 106 have been fixed under the image reading position. In this state, the image of the original S which passes through the predetermined reading position is read. Thereafter, the original S whose image has been read passes through the platen roller 506 and the conveying rollers 507 and 508, is conveyed from the left edge of the platen glass 102 by the ejecting roller 509, and is ejected onto the original tray 502.

In the case of reading the images on both sides of the original S, when the rear edge of the original S conveyed by the ejecting roller 509 exceeds a branch portion 510, the ejecting roller 509 is reversed and the original S is conveyed to the conveying roller 505 again. In this manner, the obverse and reverse surfaces of the original S are reversed and the image is read. Thereafter, the obverse and reverse surfaces of the original S are reversed again and the original S is ejected.

Also in the digital scanner 1 having such a construction, a construction of an index plate on the platen glass 102 is similar to that in the first or second embodiment. A positional relation between a conveying region of the original and the index plate is also similar to that in the first or second embodiment. That is, the index plate is provided out of the original conveying region of the ADF 501 so as to be deviated in the depth direction from the original conveying region (the direction perpendicular to the paper surface of FIG. 9).

In the foregoing first and second embodiments, the construction in which the reversing unit for reversing the original from which the image of the obverse surface has been read and the ejecting unit for ejecting the original whose image has been read are arranged so as to face each other through the platen glass 102 has been shown as an example. However, it is also possible to use a construction in which the ejecting unit and the reversing unit are arranged at opposite positions through the platen glass 102.

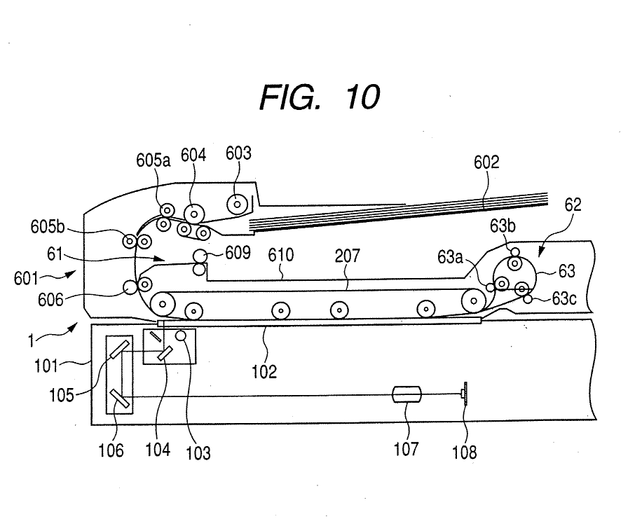

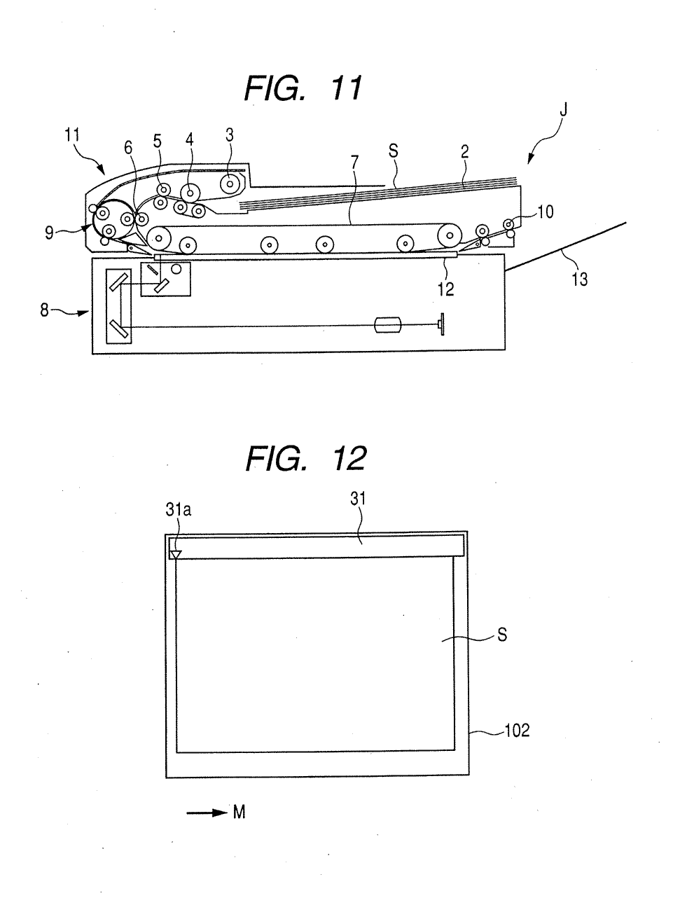

FIG. 10 is a diagram for describing the construction of the digital scanner 1 in which the ejecting unit and the reversing unit are arranged at the opposite positions through the platen glass as mentioned above. In FIG. 10, the same and corresponding portions as those in FIG. 1 mentioned above are designated by the same reference numerals.

In FIG. 10, an ADF 601 is provided over the scanner unit 101 so as to be closable for the scanner unit 101. The originals S are stacked onto an original tray 602. A pickup roller 603 feeds the originals S stacked on the original tray 602. A separating roller 604 separates the originals S fed by the pickup roller 603. Conveying roller pairs 605a and 605b convey the original separated by the separating roller 604.

A registration roller pair 606 conveys the original S conveyed by the conveying roller pairs 605a and 605b in the direction of the conveying belt 207. An ejecting unit 61 is provided over the conveying belt 207 and ejects the original read by the scanner unit 101 onto a sheet discharging tray 610. The ejecting unit 61 has a sheet discharging roller pair 609 for ejecting the original ejected from one end side (left side) of the platen glass 102 onto the sheet discharging tray 610.

A reversing unit 62 is provided on the other end side (right side) of the platen glass 102 and reverses the reverse and obverse surfaces of the original. The reversing unit 62 has: a circular conveying path 63; and reverse conveying roller pairs 63a to 63c provided for the circular conveying path 63.

First, the reversing unit 62 conveys the original by the reverse conveying roller pairs 63a to 63c in order to reverse the reverse and obverse surfaces of the original ejected from the right side of the platen glass 102 by the conveying belt 207. Thereafter, the reversing unit 62 conveys the original again onto the conveying belt 207 from the right side of the platen glass 102.

Subsequently, the original image reading operation which is executed by the digital scanner 1 having such an ADF 601 in the conveyance original reading mode will be described.

First, the originals S set on the original tray 602 are separated and fed one by one by the pickup roller 603 and the separating roller 604. Thereafter, the original S passes through the conveying roller pairs 605a and 605b and is conveyed onto the platen glass 102 from the left side of the platen glass.

Subsequently, on the platen glass 102, the original S is conveyed by the conveying belt 207 and stopped at the predetermined reading position on the platen glass 102. After the original S was stopped at the predetermined reading position on the platen glass 102 in this manner, the original image is read by the scanner unit 101.

In the case of reading only the image of one side, after the image of one side was read, the conveying belt 207 is reversed, the original S is ejected from the left side of the platen glass 102, passes through the registration roller pair 606, and is ejected onto the sheet discharging tray 610 by the sheet discharging roller pair 609.

In the case of reading the images of both sides of the original, after the image of one side of the original was read, the original S is ejected from the right side of the platen glass 102 by the conveying belt 207. Subsequently, the reverse and obverse surfaces of the original are reversed by the reversing unit 62, and the original S is guided again by the platen glass 102. That is, the original ejected from the right side of the platen glass 102 by the conveying belt 207 is sequentially conveyed by the reverse conveying roller pairs 63a to 63c of the circular conveying path 63 and conveyed again from the right side of the platen glass 102.

Thereafter, the original S is stopped at the predetermined position on the platen glass 102 by the conveying belt 207 and the image of the other side is read by the scanner unit 101. After the images of both sides were read, the original S is conveyed from the left side of the platen glass 102 by the conveying belt 207, passes through the registration roller pair 606, and is ejected onto the sheet discharging tray 610 by the sheet discharging roller pair 609.

Also in the digital scanner 1 having such a construction, a construction of an index plate on the platen glass 102 is similar to that in the first or second embodiment mentioned above. A positional relation between an original conveying region of the original by the registration roller pair 606 and the index plate is also similar to that in the first or second embodiment. That is, the index plate is provided out of the original conveying region of the ADF 601 so as to be deviated in the depth direction from the original conveying region (the direction perpendicular to the paper surface of FIG. 10).

Although the construction of the image reading apparatus sole body has been described above, the invention is not limited to it. For example, naturally, the invention can be also applied to an image reading apparatus provided for an image forming apparatus having an image forming unit for forming an image based on the image information read by the image reading apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-149518, filed Jun. 5, 2007, which is hereby incorporated by reference herein in its entirety.

What is claimed is:

1. An image reading apparatus comprising:
a setting unit on which a sheet is set;
a sheet conveying unit which conveys the sheet onto the setting unit;
a reading unit which can read an image of the sheet which is conveyed onto the setting unit by the sheet conveying unit and can read the image of the sheet set onto the setting unit; and
an abutting unit which abuts an edge of the sheet which is set onto the setting unit, said edge of the sheet crosses a sheet conveying direction of the sheet conveying unit, wherein said abutting unit is provided at a position where it is not come into contact with the sheet that is conveyed by the sheet conveying unit.

2. An apparatus according to claim 1, further comprising a control unit which controls an image reading range in a direction which perpendicularly crosses the sheet conveying direction of the reading unit,
and wherein the control unit controls the image reading range by the reading unit when the sheet conveyed by the sheet conveying unit is read so as to be deviated from the image reading range when the sheet set on the setting unit is read in the direction which perpendicularly crosses the sheet conveying direction and in such a direction as to be away from the abutting unit by a distance corresponding to a length of the abutting unit in the direction which perpendicularly crosses the sheet conveying direction.

3. An apparatus according to claim 1, wherein the sheet conveying unit conveys the sheet onto the setting unit from an first side of the setting unit, and after the reading of the image of the sheet conveyed onto the setting unit was finished the sheet conveying unit can convey the sheet to discharge the sheet form the first side of setting unit.

4. An apparatus according to claim 1, wherein after the reading of the image of the sheet conveyed onto the setting unit was finished, the sheet conveying unit selectively conveys the sheet in the same direction as the sheet conveying direction or the direction opposite to the sheet conveying direction.

5. An apparatus according to claim 1, wherein the abutting unit is arranged on the front side of an apparatus main body.

6. An apparatus according to claim 1, further comprising a second abutting unit, to which an edge of the sheet which is set onto the setting unit, that is, the edge which is parallel with the sheet conveying direction of the sheet conveying unit is abutted, and which is extended in the sheet conveying direction.

7. An apparatus according to claim 1, wherein the sheet conveying unit has a conveying belt which covers the setting unit.

8. An image reading apparatus comprising:
a setting unit on which a sheet is set;
a sheet conveying unit which conveys the sheet onto the setting unit;
a reading unit which can read an image of the sheet which is conveyed onto the setting unit by the sheet conveying unit and can read the image of the sheet set onto the setting unit;
a first abutting unit which abuts a first edge of the sheet which is set onto the setting unit, and
a second abutting unit which abuts a second edge of the sheet which is set onto the setting unit, wherein the first edge and the second edge are perpendicular each other,
wherein said first and second abutting unit is provided at a position where it is not come into contact with the sheet that is conveyed by the sheet conveying unit, and
wherein after the reading of the image of the sheet conveyed onto the setting unit was finished, the sheet conveying unit selectively conveys the sheet in the same direction as the sheet conveying direction or the direction opposite to the sheet conveying direction.

9. An apparatus according to claim 8, further comprising a control unit which controls an image reading range in a direction which perpendicularly crosses the sheet conveying direction of the reading unit,
wherein the control unit controls the image reading range by the reading unit when the sheet conveyed by the sheet conveying unit is read so as to be deviated from the image reading range when the sheet set on the setting unit in the direction which perpendicularly crosses the sheet conveying direction and in such a direction as to be away from the abutting unit by a distance corresponding to a length of the abutting unit in the direction which perpendicularly crosses the sheet conveying direction.

10. An apparatus according to claim 8, wherein the abutting unit is arranged on the front side of an apparatus main body.

11. An apparatus according to claim 8, wherein the sheet conveying unit has a conveying belt which covers the setting unit.
